(19) United States
(12) Patent Application Publication
(10) Pub. No.: US 2010/0209724 A1
(43) Pub. Date: Aug. 19, 2010

(54) PRINTING PASTE AND THE USE THEREOF FOR THE PRODUCTION OF AN ELECTROLUMINESCENT FILM

(75) Inventors: Manfred Hartmann, Ziegelberg (DE); Andreas Nübler, Landshut (DE)

Correspondence Address: Studebaker & Brackett PC, One Fountain Square, 11911 Freedom Drive, Suite 750, Reston, VA, 20190, US

(73) Assignee: SCHREINER GROUP GMBH & CO. KG, Oberschleissheim (DE)

(21) Appl. No.: 12/599,184

(22) PCT Filed: May 7, 2008
(86) PCT No.: PCT/EP08/55656

§ 371 Date: Mar. 2, 2010

(30) Foreign Application Priority Data
May 8, 2007 (EP) 07107710.1

(51) Int. Cl. C09K 11/02; B05D 3/06; B32B 27/30

(52) U.S. Cl. 428/522; 427/514; 252/301.36

(57) ABSTRACT

A plastic substrate is disclosed that is provided with a conductive layer wherein an electroluminescent layer is applied to a conductive layer. In order to produce the electroluminescent layer, a printing paste is used that is preferably applied by means of screen printing. The printing paste is based on a transparent, acrylate-based UV printing lacquer that is known per se. The UV printing lacquer is mixed with electroluminophores at a ratio of at least two parts by weight UV printing lacquer and three parts by weight electroluminophores. A phthalic acid emollient is added. The dielectric layer results from the application, preferably the imprinting, of a dielectric paste. Preferably, a composition is selected from the dielectric paste that is similar to that of the printing paste. Here, however, instead of the luminescent pigments, a filler is used, preferably a mixture of barium titanate and titanium dioxide. The back electrode may advantageously be produced by applying (preferably using pressure) a silver conductor paste already used for conventional electroluminescent elements.

This invention relates to a printing paste, in particular a printing paste for the production of an electroluminescent layer on a deep-draw plastic film. This invention also relates to a process for the production of an electroluminescent film, in which an electroluminescent layer on a deep-draw plastic film is produced.

Electroluminescent films with inorganic luminescent pigments (also referred to as electroluminophores) are used in a variety of ways as large-area illuminants, for example for the back-lighting of displays, the back-lighting of operating elements, and the like. The design of an electroluminescent film already comprises a film substrate, two electrode layers, and an electroluminescent layer that is arranged between the electrode layers and that contains the electroluminophores. The latter are often microencapsulated, bonded into a binder matrix, and can consist of, for example, zinc sulfides, which produce various relatively narrow-band emission spectra based on doping or Co-doping and preparation processes.

The luminescence is created by an alternating electrical field, which is produced by attaching the electrode layers to an ac voltage source.

In most cases, electroluminescent films are built up by printing, i.e., a suitable plastic film substrate that is already coated to be conductive in some cases (for example, ITO-vapor-deposited or -sputtered) is printed with the layers that are necessary for producing an electroluminescent design.

In practical application, for example in the illumination of operating elements in automotive engineering, there is often the desire not only to back-light a flat or slightly curved surface, but rather to use more strongly curved luminescent surfaces that in some cases are also deformed three-dimensionally in a complex manner.

Here, the technology that is used to date often pushes the limits, in particular when the formed surfaces are to be back-injected to improve mechanical stability and for better sealing against environmental influences.

The printing pastes that are preferably used conventionally require high drying temperatures, which often prevents or at least greatly limits the use of heat-sensitive plastic film substrates. In the back-injection with hot masses, the problem is reinforced.

To date, people have made do with the use of heat-stabilized PET or PC films that are printed with solvent-based systems and are exposed to, for example, six- to ten-minute drying times at 120° C.

The possibilities for deforming, back-injection and lamination are still greatly limited in such conventional electroluminescent films, however. Thus, the process temperatures always have to be kept as low as possible. Also, the possible depth of both concave and convex formations is greatly limited to avoid loss of quality or even breakdown of the completed luminescent agent.

The object of this invention is therefore to provide possibilities for special production by the printing of readily deformable and back-injectable electroluminescent films, and in this connection to allow the applicant as free a material selection as possible when using the plastic film substrate.

According to one aspect of this invention, this object is achieved by means of a printing paste according to claim 1. Advantageous embodiments can be configured according to one of Claims 2-7.

According to another aspect of this invention, the basic object is achieved by a process according to claim 8. Advantageous embodiments of the process according to the invention can be configured according to one of Claims 9-24.

According to another aspect of this invention, the basic object is achieved by an electroluminescent film according to claim 25.

In principle, any variant of the invention that is described or indicated within the scope of this application can be especially advantageous depending on the economic and technical conditions in individual cases. Unless indicated to the contrary, or if in principle they can be implemented technically, individual features of the described embodiments can be exchanged or combined with one another and also with measures known from the prior art per se.

Below, with the assistance of the related drawing based on an example, it is explained in more detail how especially preferred embodiments of this invention can be constructed. In this case, the drawing is purely schematic and, for the sake of clarity, not drawn to scale. In particular, ratios of dimensions to one another can deviate from actual embodiments. Thus, for example, the thickness of individual film layers or plies is depicted greatly out of proportion.

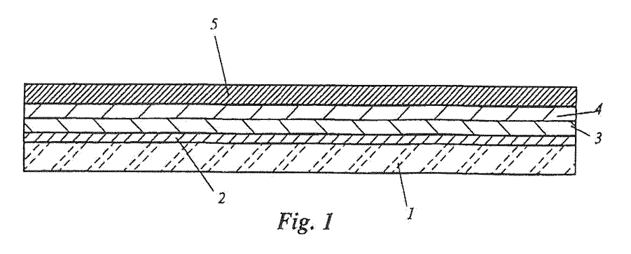

Therein, FIG. 1 shows a deep-draw electroluminescent film that can be produced by a process according to the invention.

### EXAMPLE

The example that is explained makes it possible to provide a deep-draw, back-injectable electroluminescent film, i.e., to form in particular an electroluminescent layer structure so that it can also be printed on heat-sensitive materials, such as, for example, PMMA, PVC and (in particular non-heat-stabilized) PC. Also, the invention is particularly suitable for the provision of a back-lighting of lenticular films.

The application of the individual layers can be done in batch operation or else continuously in belt operation. Also, a mixture of both types of operation is possible.

First, an at least partially transparent or even clear plastic substrate 1, which is provided with a conductive layer 2, is introduced. The latter can be produced in advance by printing with a water-based organic conductive lacquer (or application thereof in some other way). The substrate strength can preferably be 175 to 800 micrometers.

The electroluminescent layer 3 is applied to the conductive layer 2. In some cases, however, it may be advantageous to apply a non-conductive intermediate layer (not shown) before the production of the electroluminescent layer 3.

To produce the electroluminescent layer 3, a printing paste is used, which is preferably applied by means of screen printing, but optionally also with another suitable technique, to the conductive layer 2 (or the above-mentioned intermediate layer).

The basis of the printing paste is a transparent, acrylate-based UV printing lacquer that is known in the art, as it is also commercially available, for example, under the name DMU TYPE (2240563_{—}02) (manufacturer COATES SCREEN INKS GmbH) in many forms. An advantageous composition can contain 25-50% monoalkyl- or monoaryl- or monoalkylaryl esters of acrylic acid, 25-50% other acrylates, and 10-25% 1-vinyl-2-pyrrolidine (EG-No. 201-800-4; CAS No. 88-12-0) (data in percent by weight). The UV printing lacquer is mixed with the latter at least in the ratio of two parts by weight to three parts by weight of electroluminophores (also referred to as EL-phosphorus or luminescent pigments). The maximum pasting ratio is two parts by weight of electroluminophores to one part of printing lacquer, since otherwise there is inadequate adhesion to the substrate.

The selection of the electroluminophores (known in the art) is carried out—as in the conventional inorganic electroluminescent elements—according to the desired luminescent properties, in particular luminescent colors.

Because of the high pigment concentration and the layer thickness of about 35-45 micromers resulting therefrom, the deformability would be considerably impaired. To offset this, a phthalic acid emollient (commercially available, e.g., benzyloctylphthalate-type sanitizer 261A from the supplier Ferro) is added at a proportion of at least 0.2% by weight to at most 1.5% by weight.

If the paste is printed directly on the conductive layer 2 that consists of water-based organic conductive lacquer, a silane adhesive is preferably used to achieve good adhesion and temperature stability between the systems (even against, for example, 265° C. hot injection-molding mass in the case of later back-injection). This silane adhesive has two different molecular branches that can be activated. One side reacts with the atoms on the conductive lacquer layer 2 that is to be printed in order to form a solid compound. The other side reacts with the resin molecules of the printing paste. The minimum additional volume of the adhesive to the printing paste is about 0.1% by weight; the maximum additional volume is 0.7% by weight to ensure deformability.

By applying, preferably printing, a dielectric paste, the dielectric layer 4 is produced. A composition similar to the printing paste is preferably selected for the dielectric paste. Instead of the luminescent pigment, however, a filler, preferably a mixture that consists of barium titanate and titanium dioxide, is used here. To achieve as high a relative dielectricity constant (∈ᵣ value) as possible, the barium titanate portion should be at least 80% by weight. The remaining 20 percent of titanium dioxide is used for white pigmentation, by which the dielectric layer 4 also obtains the function of a reflector layer. The minimum pasting ratio is two parts by weight of filler to one part by weight of (acrylate-based, UV-settable) printing lacquer. The maximum pasting ratio is 13 to 5 parts by weight. Preferably, an emollient, in particular an emollient of the above-cited type, is also added here. An especially good homogenization is possible in this mixture with a three-roller mill with as small a gap-width adjustment as possible and multiple passages.

By using UV radiation, a stack-dried condition is reached; the optimum adhesion, chemical strength, and temperature stability are achieved via thermal afterdrying either of each individual layer or else after printing all layers, in some cases even by subsequent back-injection with a corresponding hot-injection spraying mixture.

The back electrode 5 can advantageously be produced by applying (preferably by printing) a highly filled silver conductor paste that is already used for conventional electroluminescent elements.

A highly filled silver conductor paste reflects UV radiation so strongly that thorough drying at belt speeds of about three meters per minute, which is advantageous to avoid excessive substrate heating, is no longer ensured. As a remedy, the printing of the back electrode 5 can be done here in two thin layers (screen printing tissue, e.g., polyester 130 S) with the addition of a photoinitiator in an amount of 0.1% by weight up to a maximum of 2% by weight. As an initiator, in particular a mixture that consists of 2-hydroxy-2-methyl-1-phenyl-1-propanone and 2,4,6-trimethylbenzoyldiphenylphosphine oxide is suitable, when the emission widths of commercially available emitters are to be covered. By the selected photoinitiator surplus, the reactivity is accelerated, and at the same time, color adhesion is enhanced by more pronounced depth-hardening. The photoinitiator is free of yellowing and thus does not impair the color location of the electroluminescent film that is used as a luminescent agent.

It is especially advantageous to predry the electroluminescent film as printed above before the deformation of the electroluminescent film and optionally subsequent back-injection of the deformed electroluminescent film for at least 48 hours at 50° C. to avoid the formation of bubbles.

1. A printing paste for the production of an electroluminescent layer on a deep-draw plastic film, whereby as components, the printing paste has
a UV-settable, acrylate-based printing lacquer,
inorganic electroluminophores, and
an emollient.

2. The printing paste according to claim 1, whereby the ratio of the percent by weight of the electroluminophores to the percent by weight of the printing lacquer is at least 3 to 2 and at most 2 to 1.

3. The printing paste according to claim 1, whereby the emollient has a phthalic acid derivative.

4. The printing paste according to claim 1, whereby the percent by weight of the emollient to the printing paste is at least 0.2 percent and at most 1.5 percent.

5. The printing paste according to claim 1, to which an adhesive is added.

6. The printing paste according to claim 5, whereby the percent by weight of the adhesive to the printing paste is at least 0.1 percent and at most 0.7 percent.

7. The printing paste according to claim 5, whereby the adhesive is a silane adhesive.

8. A process for the production of an electroluminescent film, comprising the following steps:
preparing a deep-draw plastic film that is provided with a first electrically conductive layer,
producing an electroluminescent layer by applying a printing paste according to claim 1 and subsequent action of UV radiation, and
producing a second electrically conductive layer.

9. The process according to claim 8, whereby the plastic film has a film substrate that primarily consists of polyvinyl chloride, polymethylmethacrylate, polycarbonate or polypropylene.

10. The process according to claim 8, whereby the preparation of the plastic film comprises the application of a water-based organic conductive lacquer on a film substrate.

11. The process according to claim 8, whereby a dielectric layer is produced by applying a paste before the application of the second electrically conductive layer.

12. (canceled)

13. The process according to claim 8, whereby the filler that is used contains a white pigment.

14. The process according to claim 13, whereby a mixture that consists of barium titanate and titanium dioxide is used as the filler.

15. The process according to claim 14, whereby the ratio of the percent by weight of the barium titanate to the percent by weight of titanium dioxide is at least 80 to 20.

16. The process according to claim 8, whereby the ratio of the percent by weight of the filler to the percent by weight of the printing lacquer is at least 2 to 1 and at most 13 to 5.

17. The process according to claim 8, whereby the second electrically conductive layer is produced by applying a silver conductor paste.

18. The process according to claim 17, whereby the silver conductor paste is applied in two coats.

19. The process according to claim 18, whereby a photoinitiator is added to the silver conductor paste.

20. The process according to claim 19, whereby the photoinitiator contains 2-hydroxy-2-methyl-1-phenyl-1-propanone and/or 2,4,6-trimethylbenzoyldiphenyl-phosphine oxide.

21. The process according to claim 19, whereby at least 0.1 percent by weight and at most 2 percent by weight of photoinitiator is added to the silver conductor paste.

22. The process according to claim 8, whereby a drying time of at least 24 hours is carried out at least 40° C. and at most 60° C.

23. The process according to claim 8, whereby the electroluminescent film is plastically deformed after the production of the second electrically conductive layer.

24. The process according to claim 23, whereby the electroluminescent film is back-injected after the deformation.

25. Electroluminescent film, which is produced with a process according to claim 8.

26. The process according to claim 8, whereby the ratio of the percent by weight of the electroluminophores to the percent by weight of the printing lacquer is at least 3 to 2 and at most 2 to 1.

27. The process according to claim 8, whereby the emollient has a phthalic acid derivative.

28. The process according to claim 8, whereby the percent by weight of the emollient to the printing paste is at least 0.2 percent and at most 1.5 percent.

29. The process according to claim 8, to which an adhesive is added.

30. The process according to claim 29, whereby the percent by weight of the adhesive to the printing paste is at least 0.1 percent and at most 0.7 percent.

31. The process according to claim 29, whereby the adhesive is a silane adhesive.
